(19) United States
(12) Patent Application Publication
(10) Pub. No.: US 2020/0249591 A1
(43) Pub. Date: Aug. 6, 2020

(54) THERMOPLASTIC POLYURETHANE MATERIAL FOR ELECTROPHOTOGRAPHY-BASED ADDITIVE MANUFACTURING AND METHOD OF MAKING SAME

(71) Applicant: Evolve Additive Solutions, Inc., Minnetonka, MN (US)

(72) Inventors: Maura A. Sweeney, Geneseo, NY (US); Trevor I. Martin, Burlington (CA); Mark E. Mang, Rochester, NY (US)

(21) Appl. No.: 16/648,996

(22) PCT Filed: Sep. 20, 2018
(86) PCT No.: PCT/US2018/051941

§ 371 Date: Mar. 19, 2020

Related U.S. Application Data
(60) Provisional application No. 62/560,996, filed on Sep. 20, 2017.

(51) Int. Cl. G03G 9/087; B33Y 10/00; B33Y 70/00; B33Y 40/10; G03G 15/22; B29C 64/147; B29C 64/314; G03G 9/097; G03G 9/08

(52) U.S. Cl. CPC G03G 9/08764; B33Y 10/00; B33Y 70/00; B33Y 40/10; G03G 9/0806; B29C 64/147; B29C 64/314; G03G 9/09791; G03G 9/0819; G03G 15/224

(57) ABSTRACT

A part material for printing three-dimensional parts with a selective deposition-based additive manufacturing system has a composition having a thermoplastic polyuiethane polymer and a charge control agent. The part material is provided in a powder form having a D90/D50 particle size distribution and a D50/D10 particle size distribution each ranging from about 1.00 to about 1.40, wherein the part material is configured for use in the selective deposition-based additive manufacturing system having a layer transfusion assembly for printing the three-dimensional parts in a layer-by-layer manner.

### BACKGROUND

The present disclosure relates to additive manufacturing systems for printing three-dimensional (3D) parts and support structures. In particular, the present disclosure relates to thermoplastic polyurethane consumable materials for use in a selective deposition additive manufacturing system to print 3D parts.

Additive manufacturing is generally a process for manufacturing a three-dimensional (3D) object in additive manner utilizing a computer model of the objects The basic operation of an additive manufacturing system consists of slicing a three-dimensional computer model into thin cross sections, translating the result into position data, and the position data to control equipment which manufacture a three-dimensional structure in a layerwise manner using one or more additive manufacturing techniques. Additive manufacturing entails many different approaches to the method of fabrication, including fused deposition modeling, ink jetting, selective laser sintering, powder/binder jetting, electron-beam melting, electrophotographic imaging, and stereolithographic processes.

In fabricating 3D parts by depositing layers of a part material, supporting layers or structures are typically built underneath overhanging portions or in cavities of objects under construction, which are not supported by the part material itself. A support structure may be built utilizing the same deposition techniques by which the part material is deposited. The host computer generates additional geometry acting as a support structure for the overhanging or free-space segments of the 3D part being formed, and in some cases, for the sidewalls of the 3D part being formed. The support material adheres to the part material during fabrication, and is removable from the completed 3D part when the printing process is complete.

In an electrostatographic 3D printing process, slices of the digital representation of the 3D part and its support structure are printed or developed using an electrophotographic engine. The electrostatographic engine generally operates in accordance with 2D electrophotographic printing processes, using charged powder materials that are formulated for use in building a 3D part (e.g., a polymeric toner material). The electrostatographic engine typically uses a support drum that is coated with a photoconductive material layer, where latent electrostatic images are formed by electrostatic charging following image-wise exposure of the photoconductive layer by an optical source. The latent electrostatic images are then moved to a developing station where the polymeric toner is applied to charged areas, or alternatively to discharged areas of the photoconductive insulator to form the layer of the charged powder material representing a slice of the 3D part. The developed layer is transferred to a transfer medium, from which the layer is transfused to previously printed layers with heat and pressure to build the 3D part.

In addition to the aforementioned commercially available additive manufacturing techniques, a novel additive manufacturing technique has emerged, where particles are first selectively deposited in an imaging process, forming a layer corresponding to a slice of the part to be made; the layers are then bonded to each other, forming a part. This is a selective deposition process, in contrast to, for example, selective sintering, where the imaging and part formation happens simultaneously. The imaging step in a selective deposition process can be done using electrophotography. In two-dimensional (2D) printing, electrophotography (i.e., xerography) is a popular technology for creating 2D images on planar substrates, such as printing paper. Electrophotography systems include a conductive support drum coated with a photoconductive material layer, where latent electrostatic images are formed by charging and then image-wise exposing the photoconductive layer by an optical source. The latent electrostatic images are then moved to a developing station where toner is applied to charged areas of the photoconductive insulator to form visible images. The formed toner images are then transferred to substrates (e.g., printing paper) and affixed to the substrates with heat or pressure.

### SUMMARY

An aspect of the present disclosure is directed to a part material for printing three-dimensional parts with a selective deposition-based additive manufacturing system has a composition having a thermoplastic polyurethane polymer and a charge control agent. The part material is provided in a powder form having a D90/D50 particle size distribution and a D50/D10 particle size distribution each ranging from about 1.00 to about 1.40, wherein the part material is configured for use in the selective deposition-based additive manufacturing system having a layer transfusion assembly for printing the three-dimensional parts in a layer-by-layer manner.

Another aspect of the present disclosure is directed to a part material for printing 3D parts with a selective deposition-based additive manufacturing system, where the part material has a composition that includes TPU, a charge control agent from about 0.1% by weight, a flow control agent constituting from about 0.1% by weight to about 10% by weight of the part material and a heat absorber constituting from about 0.05% by weight to about 10% by weight of the part material. The part material is provided in a powder form having a D90/D50 particle size distribution and a D50/D10 particle size distribution each ranging from about 1.00 to about 1.40, wherein the part material is configured for use in the electrophotography-based additive manufacturing system having a layer transfusion assembly for printing the three-dimensional parts in a layer-by-layer manner.

Another aspect of the present disclosure is directed to a method for printing a three-dimensional part with a selective deposition-based additive manufacturing system having a layer development engine, a transfer medium, and a layer transfusion assembly. The method includes providing a part material to the electrophotography-based additive manufacturing system, the part material compositionally comprising a charge control agent, and a thermoplastic polyurethane polymer and has a powder form having a D90/D50 particle size distribution and a D50/D10 particle size distribution each ranging from about 1.00 to about 1.40. The method also includes triboelectrically charging the part material to a Q/M ratio having a negative charge or a positive charge, and a magnitude ranging from about 5 micro-Coulombs/gram to about 50 micro-Coulombs/gram and developing layers of the three-dimensional part from the charged part material with the layer development engine. The method includes electrostatically attracting the developed layers from the electrophotography engine to the transfer medium, and moving the attracted layers to the layer transfusion assembly with the transfer medium. The method also includes transfusing the moved layers to previously-printed layers of the three-dimensional part with the layer transfusion assembly using heat and pressure over time.

Another aspect of the present disclosure is directed to a method of producing thermoplastic polyurethane particles configured for use in a selective deposition-based additive manufacturing system, the method includes dissolving thermoplastic polyurethane in an organic solvent into an organic intermediary composition, and adding an aqueous solution to the organic intermediary composition. The method includes emulsifying the organic intermediary composition in the aqueous solution and heating the emulsion to evaporate the organic solvent from the emulsion. The method includes agglomerating the thermoplastic polyurethane into particles having a D90/D50 particle size distribution and a D50/D10 particle size distribution each ranging from about 1.00 to about 1.40, and separating the thermoplastic polyurethane particles from the aqueous solution.

Another aspect of the present disclosure includes a method of producing thermoplastic polyurethane particles configured for use in a selective deposition-based additive manufacturing system. The method includes mixing thermoplastic polyurethane with an emulsifying agent and a surfactant in an extruder; and adding an aqueous solution to the extruder to form an emulsion. The method includes agglomerating the thermoplastic polyurethane into particles having a D90/D50 particle size distribution and a D50/D10 particle size distribution each ranging from about 1.00 to about 1.40, and separating the thermoplastic polyurethane particles from the aqueous solution.

### DEFINITIONS

Unless otherwise specified, the following terms as used herein have the meanings provided below:

The term “copolymer” refers to a polymer having two or more monomer species.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the inventive scope of the present disclosure.

Reference to “a” chemical compound refers one or more molecules of the chemical compound, rather than being limited to a single molecule of the chemical compound. Furthermore, the one or more molecules may or may not be identical, so long as they fall under the category of the chemical compound.

The terms “at least one” and “one or more of” an element are used interchangeably, and have the same meaning that includes a single element and a plurality of the elements, and may also be represented by the suffix “(s)” at the end of the element.

Directional orientations such as “above”, “below”, “top”, “bottom”, and the like are made with reference to a direction along a printing axis of a 3D part. In the embodiments in which the printing axis is a vertical z-axis, the layer-printing direction is the upward direction along the vertical z-axis. In these embodiments, the terms “above”, “below”, “top”, “bottom”, and the like are based on the vertical z-axis. However, in embodiments in which the layers of 3D parts are printed along a different axis, the terms “above”, “below”, “top”, “bottom”, and the like are relative to the given axis.

The term “providing”, such as for “providing a material” and the like, when recited in the claims, is not intended to require any particular delivery or receipt of the provided item. Rather, the term “providing” is merely used to recite items that will be referred to in subsequent elements of the claim(s), for purposes of clarity and ease of readability.

The term “selective deposition” refers to an additive manufacturing technique where one or more layers of particles are fused to previously deposited layers utilizing heat and pressure over time where the particles fuse together to form a layer of the part and also fuse to the previously printed layer.

The term “electrostatography” refers to the formation and utilization of latent electrostatic charge patterns to form an image of a layer of a part, a support structure or both on a surface. Electrostatography includes, but is not limited to, electrophotography where optical energy is used to form the latent image, ionography where ions are used to form the latent image and/or electron beam imaging where electrons are used to form the latent image.

Unless otherwise specified, temperatures referred to herein are based on atmospheric pressure (i.e. one atmosphere).

The terms “about” and “substantially” are used herein with respect to measurable values and ranges due to expected variations known to those skilled in the art (e.g., limitations and variabilities in measurements).

### BRIEF DESCRIPTION OF THE DRAWINGS

FIG. 1 is a front view of an example electrophotography-based additive manufacturing system for printing 3D parts and support structures from part and support materials of the present disclosure.

FIG. 2 is a schematic front view of a pair of electrophotography engines of the system for developing layers of the part and support materials.

FIG. 3 is a schematic front view of an alternative electrophotography engine, which includes an intermediary drum or belt.

FIG. 4 is a schematic front view of a layer transfusion assembly of the system for performing layer transfusion steps with the developed layers.

FIG. 5 is a schematic diagram of a solvent/emulsification process for manufacturing thermoplastic polyurethane particles that can be utilized in an electrophotographic based additive manufacturing system.

FIG. 6 is a schematic diagram of an extrusion/emulsification process for manufacturing thermoplastic polyurethane particles that can be utilized in an electrophotographic based additive manufacturing system.

### DETAILED DESCRIPTION

The present disclosure is directed to a thermoplastic polyurethane (TPU) consumable materials which are engineered for use in a selective deposition-based additive manufacturing system, such as an electrostatography-based additive manufacturing system, to print 3D parts and/or support structures with high resolutions and fast printing rates. During a printing operation, electrostatographic engines may develop or otherwise image each layer of the part and support materials using the electrostatographic process. The developed layers are then transferred to a layer transfusion assembly where they are transfused (e.g., using heat and/or pressure over time) to print one or more 3D parts and support structures in a layer-by-layer manner.

In comparison to 2D printing, in which developed toner particles can be electrostatically transferred to printing paper by placing an electrical potential through the printing paper, the multiple printed layers in a 3D environment effectively prevents the electrostatic transfer of part and support materials after a given number of layers are printed (e.g., about 15 layers). Instead, each layer and/or previously printed portion of the 3D part may be heated to an elevated transfer temperature, and then pressed against a previously-printed layer (or to a build platform) to transfuse the layers together in a transfusion step. This allows numerous layers of 3D parts and support structures to be built, beyond what is otherwise achievable via electrostatic transfers.

As discussed below, the part material is a powder-based TPU. The part material can include a charge control agent (e.g., an internal triboelectric charge control agent), optionally a heat absorber (e.g., an infrared absorber), and may optionally include one or more additional materials, such as a flow control agent, which may also function as an external surface-treatment triboelectric charge control agent and/or a triboelectric modification additive. The TPU material is engineered for use with a selective deposition-based additive manufacturing system, such as an electrostatography-based additive manufacturing system, to print 3D parts having high part resolutions and good physical properties including improved abrasion resistance, low-temperature performance, high sheer strength, high elasticity and oil and grease resistance. This allows the resulting 3D parts to function as end-use parts, if desired.

While the present disclosure can be utilized with any electrostatography-based additive manufacturing system, the present disclosure will be described in association in an electrophotography-based (EP) additive manufacturing system. However, the present disclosure is not limited to an EP based additive manufacturing system and can be utilized with any electrostatography-based additive manufacturing system.

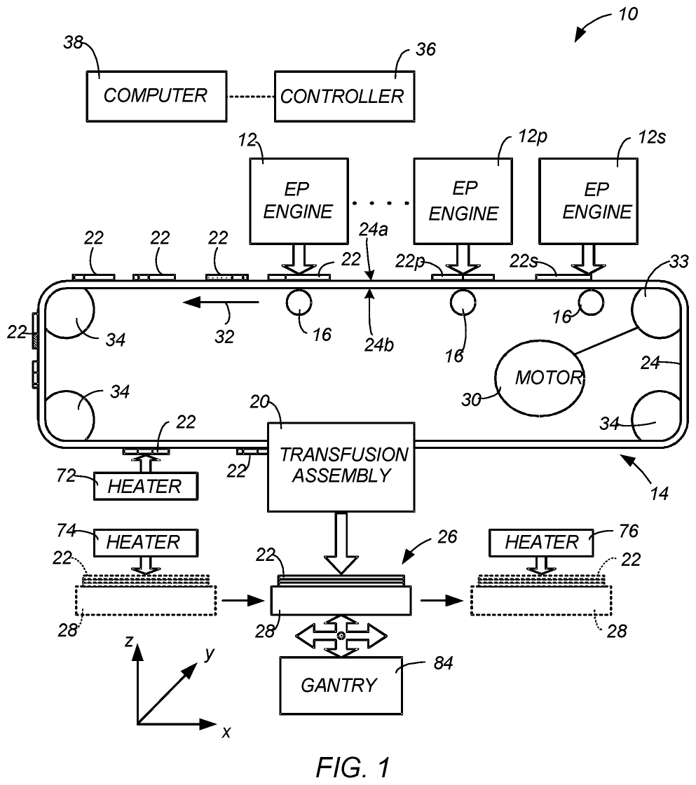

FIG. 1 is a simplified diagram of an example electrophotography-based additive manufacturing system 10 for printing 3D parts and associated support structures, in accordance with embodiments of the present disclosure. As shown in FIG. 1, system 10 includes one or more EP engines, generally referred to as 12, such as EP engines 12p and 12s, a transfer assembly 14, biasing mechanisms 16, and a transfusion assembly 20. Examples of suitable components and functional operations for system 10 include those disclosed in Hanson et al., U.S. Pat. Nos. 8,879,957 and 8,488,994, and in Comb et al., U.S. Patent Publication Nos. 2013/0186549 and 2013/0186558.

The EP engines 12p and 12s are imaging engines for respectively imaging or otherwise developing layers, generally referred to as 22, of the powder-based part and support materials, where the part and support materials are each preferably engineered for use with the particular architecture of the EP engine 12p or 12s. As discussed below, the developed layers 22 are transferred to a transfer medium 24 of the transfer assembly 14, which delivers the layers 22 to the transfusion assembly 20. The transfusion assembly 20 operates to build the 3D part 26, which may include support structures and other features, in a layer-by-layer manner by transfusing the layers 22 together on a build platform 28.

In some embodiments, the transfer medium 24 includes a belt, as shown in FIG. 1. Examples of suitable transfer belts for the transfer medium 24 include those disclosed in Comb et al., U.S. Patent Application Publication Nos. 2013/0186549 and 2013/0186558. In some embodiments, the belt 24 includes front surface 24a and rear surface 24b, where front surface 24a faces the EP engines 12, and the rear surface 24b is in contact with the biasing mechanisms 16.

In some embodiments, the transfer assembly 14 includes one or more drive mechanisms that include, for example, a motor 30 and a drive roller 33, or other suitable drive mechanism, and operate to drive the transfer medium or belt 24 in a feed direction 32. In some embodiments, the transfer assembly 14 includes idler rollers 34 that provide support for the belt 24. The example transfer assembly 14 illustrated in FIG. 1 is highly simplified and may take on other configurations. Additionally, the transfer assembly 14 may include additional components that are not shown in order to simplify the illustration, such as, for example, components for maintaining a desired tension in the belt 24, a belt cleaner for removing debris from the surface 24a that receives the layers 22, and other components.

The EP engine 12s develops layers of powder-based support material, and the EP engine 12p develops layers of powder-based part/build material. In some embodiments, the EP engine 12s is positioned upstream from the EP engine 12p relative to the feed direction 32, as shown in FIG. 1. In alternative embodiments, the arrangement of the EP engines 12p and 12s may be reversed such that the EP engine 12p is upstream from the EP engine 12s relative to the feed direction 32. In further alternative embodiments, system 10 may include three or more EP engines 12 for printing layers of additional materials, as indicated in FIG. 1.

System 10 also includes controller 36, which represents one or more processors that are configured to execute instructions, which may be stored locally in memory of the system 10 or in memory that is remote to the system 10, to control components of the system 10 to perform one or more functions described herein. In some embodiments, the controller 36 includes one or more control circuits, microprocessor-based engine control systems, and/or digitally-controlled raster imaging processor systems, and is configured to operate the components of system 10 in a synchronized manner based on printing instructions received from a host computer 38 or a remote location. In some embodiments, the host computer 38 includes one or more computer-based systems that are configured to communicate with controller 36 to provide the print instructions (and other operating information). For example, the host computer 38 may transfer information to the controller 36 that relates to the sliced layers of the 3D parts and support structures, thereby allowing the system 10 to print the 3D parts 26 and support structures in a layer-by-layer manner.

The components of system 10 may be retained by one or more frame structures (not shown for simplicity). Additionally, the components of system 10 may be retained within an enclosable housing (not shown for simplicity) that prevents components of the system 10 from being exposed to ambient light during operation.

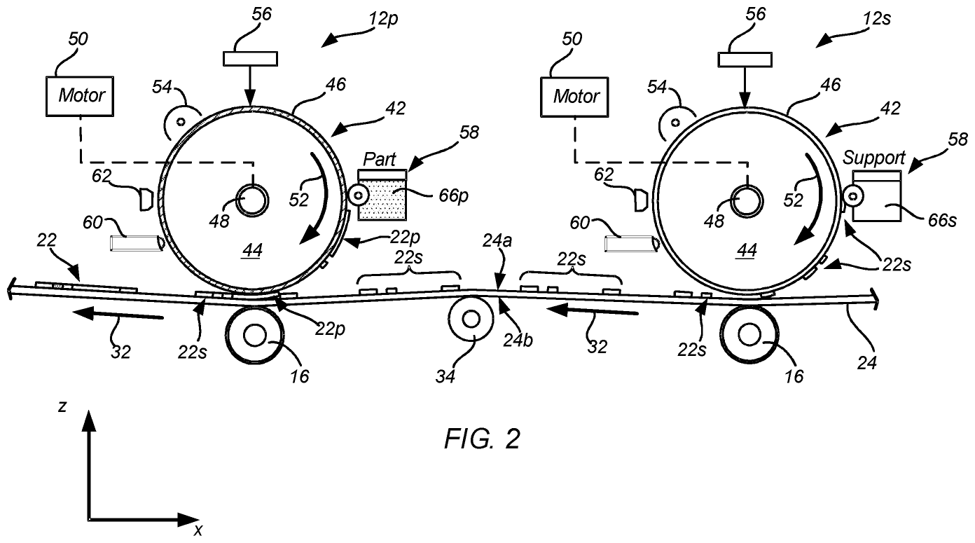

FIG. 2 is a schematic front view of the EP engines 12s and 12p of the system 10, in accordance with example embodiments of the present disclosure. In the illustrated embodiment, the EP engines 12p and 12s may include the same components, such as a photoconductor drum 42 having a conductive drum body 44 and a photoconductive surface 46. The conductive drum body 44 is an electrically-conductive drum (e.g., fabricated from copper, aluminum, tin, or the like) that is electrically grounded and configured to rotate around a shaft 48. The shaft 48 is correspondingly connected to a drive motor 50, which is configured to rotate the shaft 48 (and the photoconductor drum 42) in the direction of arrow 52 at a constant rate.

The photoconductive surface 46 is a thin film extending around the circumferential surface of the conductive drum body 44, and is preferably derived from one or more photoconductive materials, such as amorphous silicon, selenium, zinc oxide, organic materials, and the like. As discussed below, the surface 46 is configured to receive latent-charged images of the sliced layers of a 3D part or support structure (or negative images), and to attract charged particles of the part or support material to the charged or discharged image areas, thereby creating the layers of the 3D part or support structure.

As further shown, each of the example EP engines 12p and 12s also includes a charge inducer 54, an imager 56, a development station 58, a cleaning station 60, and a discharge device 62, each of which may be in signal communication with the controller 36. The charge inducer 54, the imager 56, the development station 58, the cleaning station 60, and the discharge device 62 accordingly define an image-forming assembly for the surface 46 while the drive motor 50 and the shaft 48 rotate the photoconductor drum 42 in the direction 52.

Each of the EP engines 12 uses the powder-based material (e.g., polymeric or thermoplastic toner), generally referred to herein by reference character 66, to develop or form the layers 22. In some embodiments, the image-forming assembly for the surface 46 of the EP engine 12s is used to form support layers 22s of powder-based support material 66s, where a supply of the support material 66s may be retained by the development station 58 (of the EP engine 12s) along with carrier particles. Similarly, the image-forming assembly for the surface 46 of the EP engine 12p is used to form part layers 22p of powder-based part material 66p, where a supply of the part material 66p may be retained by the development station 58 (of the EP engine 12p) along with carrier particles.

The charge inducer 54 is configured to generate a uniform electrostatic charge on the surface 46 as the surface 46 rotates in the direction 52 past the charge inducer 54. Suitable devices for the charge inducer 54 include corotrons, scorotrons, charging rollers, and other electrostatic charging devices.

Each imager 56 is a digitally-controlled, pixel-wise light exposure apparatus configured to selectively emit electromagnetic radiation toward the uniform electrostatic charge on the surface 46 as the surface 46 rotates in the direction 52 the past imager 56. The selective exposure of the electromagnetic radiation to the surface 46 is directed by the controller 36, and causes discrete pixel-wise locations of the electrostatic charge to be removed (i.e., discharged to ground), thereby forming latent image charge patterns on the surface 46.

Suitable devices for the imager 56 include scanning laser (e.g., gas or solid-state lasers) light sources, light emitting diode (LED) array exposure devices, and other exposure device conventionally used in 2D electrophotography systems. In alternative embodiments, suitable devices for the charge inducer 54 and the imager 56 include ion-deposition systems configured to selectively directly deposit charged ions or electrons to the surface 46 to form the latent image charge pattern.

Each development station 58 is an electrostatic and magnetic development station or cartridge that retains the supply of the part material 66p or the support material 66s, along with carrier particles. The development stations 58 may function in a similar manner to single or dual component development systems and toner cartridges used in 2D electrophotography systems. For example, each development station 58 may include an enclosure for retaining the part material 66p or the support material 66s and carrier particles. When agitated, the carrier particles generate triboelectric charges to attract the powders of the part material 66p or the support material 66s, which charges the attracted powders to a desired sign and magnitude, as discussed below.

Each development station 58 may also include one or more devices for transferring the charged part or the support material 66p or 66s to the surface 46, such as conveyors, fur brushes, paddle wheels, rollers, and/or magnetic brushes. For instance, as the surface 46 (containing the latent charged image) rotates from the imager 56 to the development station 58 in the direction 52, the charged part material 66p or the support material 66s is attracted to the appropriately charged regions of the latent image on the surface 46, utilizing either charged area development or discharged area development (depending on the electrophotography mode being utilized). This creates successive layers 22p or 22s as the photoconductor drum 12 continues to rotate in the direction 52, where the successive layers 22p or 22s correspond to the successive sliced layers of the digital representation of the 3D part or support structure.

The successive layers 22p or 22s are then rotated with the surface 46 in the direction 52 to a transfer region in which layers 22p or 22s are successively transferred from the photoconductor drum 42 to the belt 24 or other transfer medium, as discussed below. While illustrated as a direct engagement between the photoconductor drum 42 and the belt 24, in some preferred embodiments, the EP engines 12p and 12s may also include intermediary transfer drums and/or belts, as discussed further below.

After a given layer 22p or 22s is transferred from the photoconductor drum 42 to the belt 24 (or an intermediary transfer drum or belt), the drive motor 50 and the shaft 48 continue to rotate the photoconductor drum 42 in the direction 52 such that the region of the surface 46 that previously held the layer 22p or 22s passes the cleaning station 60. The cleaning station 60 is a station configured to remove any residual, non-transferred portions of part or support material 66p or 66s. Suitable devices for the cleaning station 60 include blade cleaners, brush cleaners, electrostatic cleaners, vacuum-based cleaners, and combinations thereof.

After passing the cleaning station 60, the surface 46 continues to rotate in the direction 52 such that the cleaned regions of the surface 46 pass the discharge device 62 to remove any residual electrostatic charge on the surface 46, prior to starting the next cycle. Suitable devices for the discharge device 62 include optical systems, high-voltage alternating-current corotrons and/or scorotrons, one or more rotating dielectric rollers having conductive cores with applied high-voltage alternating-current, and combinations thereof.

The biasing mechanisms 16 are configured to induce electrical potentials through the belt 24 to electrostatically attract the layers 22p and 22s from the EP engines 12p and 12s to the belt 24. Because the layers 22p and 22s are each only a single layer increment in thickness at this point in the process, electrostatic attraction is suitable for transferring the layers 22p and 22s from the EP engines 12p and 12s to the belt 24.

The controller 36 preferably rotates the photoconductor drums 36 of the EP engines 12p and 12s at the same rotational rates that are synchronized with the line speed of the belt 24 and/or with any intermediary transfer drums or belts. This allows the system 10 to develop and transfer the layers 22p and 22s in coordination with each other from separate developer images. In particular, as shown, each part layer 22p may be transferred to the belt 24 with proper registration with each support layer 22s to produce a combined part and support material layer, which is generally designated as layer 22. As can be appreciated, some of the layers 22 transferred to the layer transfusion assembly 20 may only include support material 66s or may only include part material 66p, depending on the particular support structure and 3D part geometries and layer slicing.

In an alternative embodiment, the part layers 22p and the support layers 22s may optionally be developed and transferred along the belt 24 separately, such as with alternating layers 22p and 22s. These successive, alternating layers 22p and 22s may then be transferred to layer transfusion assembly 20, where they may be transfused separately to print or build the 3D part 26 and support structure.

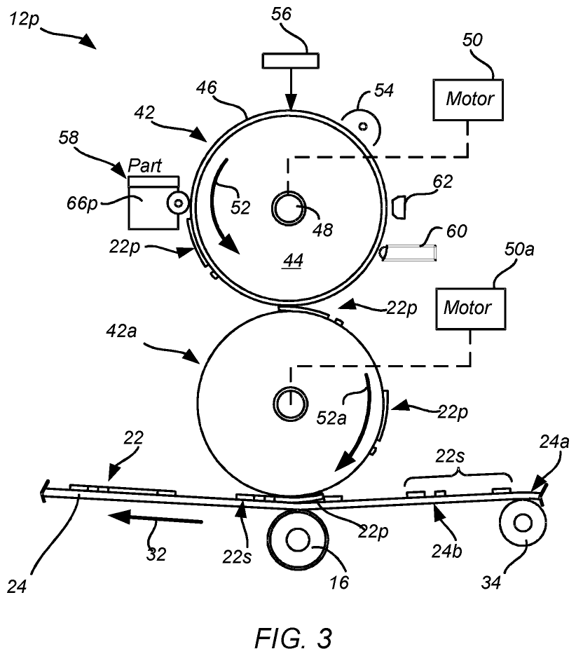

In a further alternative embodiment, one or both of the EP engines 12p and 12s may also include one or more intermediary transfer drums and/or belts between the photoconductor drum 42 and the belt or transfer medium 24. For example, as shown in FIG. 3, the EP engine 12p may also include an intermediary drum 42a that rotates in the direction 52a that opposes the direction 52, in which drum 42 is rotated, under the rotational power of motor 50a. The intermediary drum 42a engages with the photoconductor drum 42 to receive the developed layers 22p from the photoconductor drum 42, and then carries the received developed layers 22p and transfers them to the belt 24.

The EP engine 12s may include the same arrangement of an intermediary drum 42a for carrying the developed layers 22s from the photoconductor drum 42 to the belt 24. The use of such intermediary transfer drums or belts for the EP engines 12p and 12s can be beneficial for thermally isolating the photoconductor drum 42 from the belt 24, if desired.

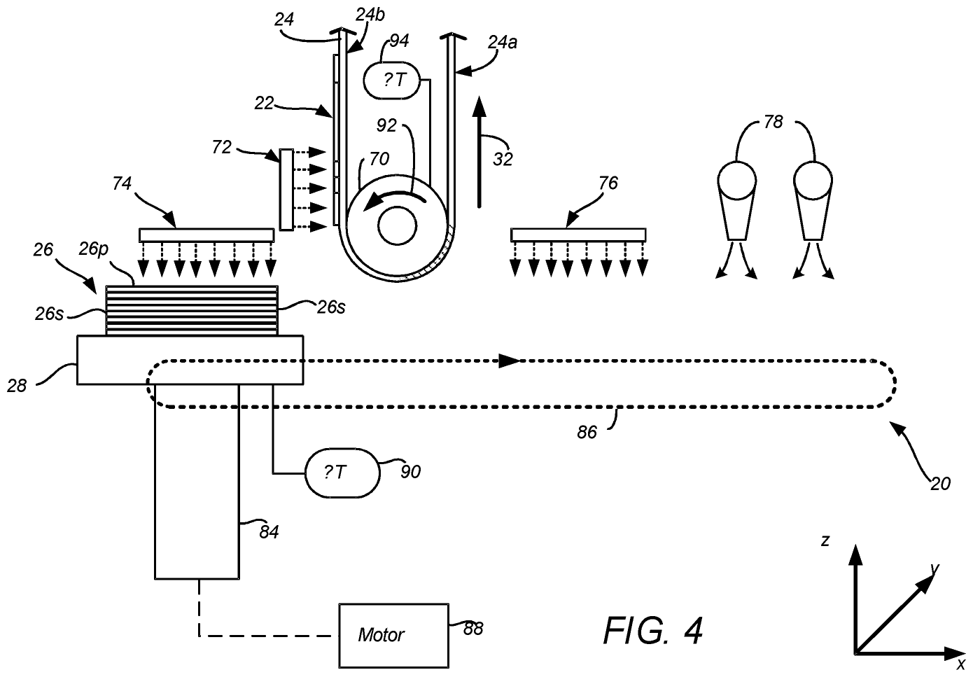

FIG. 4 illustrates an embodiment of the layer transfusion assembly 20. As shown, the transfusion assembly 20 includes the build platform 28, a nip roller 70, pre-transfusion heaters 72 and 74, an optional post-transfusion heater 76, and air jets 78 (or other cooling units). The build platform 28 is a platform assembly or platen of system 10 that is configured to receive the heated combined layers 22 (or separate layers 22p and 22s) for printing the part 26, which includes a 3D part 26p formed of the part layers 22p, and support structure 26s formed of the support layers 22s, in a layer-by-layer manner. In some embodiments, the build platform 28 may include removable film substrates (not shown) for receiving the printed layers 22, where the removable film substrates may be restrained against build platform using any suitable technique (e.g., vacuum drawing).

The build platform 28 is supported by a gantry 84 or other suitable mechanism, which can be configured to move the build platform 28 along the z-axis and the x-axis (and, optionally, also the y-axis), as illustrated schematically in FIG. 1 (the y-axis being into and out of the page in FIG. 1, with the z-, x- and y-axes being mutually orthogonal, following the right-hand rule). The gantry 84 may produce cyclical movement patterns relative to the nip roller 70 and other components, as illustrated by broken line 86 in FIG. 4. The particular movement pattern of the gantry 84 can follow essentially any desired path suitable for a given application. The gantry 84 may be operated by a motor 88 based on commands from the controller 36, where the motor 88 may be an electrical motor, a hydraulic system, a pneumatic system, or the like. In one embodiment, the gantry 84 can included an integrated mechanism that precisely controls movement of the build platform 28 in the z- and x-axis directions (and optionally the y-axis direction). In alternate embodiments, the gantry 84 can include multiple, operatively-coupled mechanisms that each control movement of the build platform 28 in one or more directions, for instance, with a first mechanism that produces movement along both the z-axis and the x-axis and a second mechanism that produces movement along only the y-axis. The use of multiple mechanisms can allow the gantry 84 to have different movement resolution along different axes. Moreover, the use of multiple mechanisms can allow an additional mechanism to be added to an existing mechanism operable along fewer than three axes.

In the illustrated embodiment, the build platform 28 can be heatable with heating element 90 (e.g., an electric heater). The heating element 90 is configured to heat and maintain the build platform 28 at an elevated temperature that is greater than room temperature (25° C.), such as at a desired average part temperature of 3D part 26p and/or support structure 26s, as discussed in Comb et al., U.S. Patent Application Publication Nos. 2013/0186549 and 2013/0186558. This allows the build platform 28 to assist in maintaining 3D part 26p and/or support structure 26s at this average part temperature.

The nip roller 70 is an example heatable element or heatable layer transfusion element, which is configured to rotate around a fixed axis with the movement of the belt 24. In particular, the nip roller 70 may roll against the rear surface 22s in the direction of arrow 92 while the belt 24 rotates in the feed direction 32. In the shown embodiment, the nip roller 70 is heatable with a heating element 94 (e.g., an electric heater). The heating element 94 is configured to heat and maintain nip roller 70 at an elevated temperature that is greater than room temperature (25° C.), such as at a desired transfer temperature for the layers 22.

The pre-transfusion heater 72 includes one or more heating devices (e.g., an infrared heater and/or a heated air jet) that are configured to heat the layers 22 on the belt 24 to a selected temperature of the layer 22, such as up to a fusion temperature of the part material 66p and the support material 66s, prior to reaching nip roller 70. Each layer 22 desirably passes by (or through) the heater 72 for a sufficient residence time to heat the layer 22 to the intended transfer temperature. The pre-transfusion heater 74 may function in the same manner as the heater 72, and heats the top surfaces of the 3D part 26p and support structure 26s on the build platform 28 to an elevated temperature, and in one embodiment to supply heat to the layer upon contact.

As mentioned above, the support material 66s of the present disclosure used to form the support layers 22s and the support structure 26s, preferably has a melt rheology that is similar to or substantially the same as the melt rheology of the part material 66p of the present disclosure used to form the part layers 22p and the 3D part 26p. This allows the part and support materials 66p and 66s of the layers 22p and 22s to be heated together with the heater 72 to substantially the same transfer temperature, and also allows the part and support materials 66p and 66s at the top surfaces of the 3D part 26p and support structure 26s to be heated together with heater 74 to substantially the same temperature. Thus, the part layers 22p and the support layers 22s may be transfused together to the top surfaces of the 3D part 26p and the support structure 26s in a single transfusion step as the combined layer 22.

Optional post-transfusion heater 76 is located downstream from nip roller 70 and upstream from air jets 78, and is configured to heat the transfused layers 22 to an elevated temperature. Again, the close melt rheologies of the part and support materials 66p and 66s allow the post-transfusion heater 76 to post-heat the top surfaces of 3D part 26p and support structure 26s together in a single post-fuse step.

As mentioned above, in some embodiments, prior to building the part 26 on the build platform 28, the build platform 28 and the nip roller 70 may be heated to their selected temperatures. For example, the build platform 28 may be heated to the average part temperature of 3D part 26p and support structure 26s (due to the close melt rheologies of the part and support materials). In comparison, the nip roller 70 may be heated to a desired transfer temperature for the layers 22 (also due to the close melt rheologies of the part and support materials).

As further shown in FIG. 4, during operation, the gantry 84 may move the build platform 28 (with 3D part 26p and support structure 26s) in a reciprocating pattern 86. In particular, the gantry 84 may move the build platform 28 along the x-axis below, along, or through the heater 74. The heater 74 heats the top surfaces of 3D part 26p and support structure 26s to an elevated temperature, such as the transfer temperatures of the part and support materials. As discussed in Comb et al., U.S. Patent Application Publication Nos. 2013/0186549 and 2013/0186558, the heaters 72 and 74 may heat the layers 22 and the top surfaces of 3D part 26p and support structure 26s to about the same temperatures to provide a consistent transfusion interface temperature. Alternatively, the heaters 72 and 74 may heat layers 22 and the top surfaces of 3D part 26p and support structure 26s to different temperatures to attain a desired transfusion interface temperature.

The continued rotation of the belt 24 and the movement of the build platform 28 align the heated layer 22 with the heated top surfaces of 3D part 26p and support structure 26s with proper registration along the x-axis. The gantry 84 may continue to move the build platform 28 along the x-axis, at a rate that is synchronized with the rotational rate of the belt 24 in the feed direction 32 (i.e., the same directions and speed). This causes the rear surface 24b of the belt 24 to rotate around the nip roller 70 to nip the belt 24 and the heated layer 22 against the top surfaces of 3D part 26p and support structure 26s. This presses the heated layer 22 between the heated top surfaces of 3D part 26p and support structure 26s at the location of the nip roller 70, which at least partially transfuses the heated layer 22 to the top layers of 3D part 26p and support structure 26s.

As the transfused layer 22 passes the nip of the nip roller 70, the belt 24 wraps around the nip roller 70 to separate and disengage from the build platform 28. This assists in releasing the transfused layer 22 from the belt 24, allowing the transfused layer 22 to remain adhered to 3D part 26p and support structure 26s. Maintaining the transfusion interface temperature at a transfer temperature that is higher than its glass transition temperature, but lower than its fusion temperature, allows the heated layer 22 to be hot enough to adhere to the 3D part 26p and support structure 26s, while also being cool enough to readily release from the belt 24. Additionally, as discussed above, the close melt rheologies of the part and support materials allow them to be transfused in the same step.

After release, the gantry 84 continues to move the build platform 28 along the x-axis to the post-transfusion heater 76. At optional post-transfusion heater 76, the top-most layers of 3D part 26p and the support structure 26s (including the transfused layer 22) may then be heated to at least the fusion temperature of the thermoplastic-based powder in a post-fuse or heat-setting step. This optionally heats the material of the transfused layer 22 to a highly fusable state such that polymer molecules of the transfused layer 22 quickly interdiffuse to achieve a high level of interfacial entanglement with 3D part 26p and support structure 26s.

Additionally, as the gantry 84 continues to move the build platform 28 along the x-axis past the post-transfusion heater 76 to the air jets 78, the air jets 78 blow cooling air towards the top layers of 3D part 26p and support structure 26s. This actively cools the transfused layer 22 down to the average part temperature, as discussed in Comb et al., U.S. Patent Application Publication Nos. 2013/0186549 and 2013/0186558.

To assist in keeping the 3D part 26p and support structure 26s at the average part temperature, in some preferred embodiments, the heater 74 and/or the heater 76 may operate to heat only the top-most layers of 3D part 26p and support structure 26s. For example, in embodiments in which heaters 72, 74, and 76 are configured to emit infrared radiation, the 3D part 26p and support structure 26s may include heat absorbers and/or other colorants configured to restrict penetration of the infrared wavelengths to within the top-most layers. Alternatively, the heaters 72, 74, and 76 may be configured to blow heated air across the top surfaces of 3D part 26p and support structure 26s. In either case, limiting the thermal penetration into 3D part 26p and support structure 26s allows the top-most layers to be sufficiently transfused, while also reducing the amount of cooling required to keep 3D part 26p and support structure 26s at the average part temperature.

The gantry 84 may then actuate the build platform 28 downward, and move the build platform 28 back along the x-axis to a starting position along the x-axis, following the reciprocating rectangular pattern 86. The build platform 28 desirably reaches the starting position for proper registration with the next layer 22. In some embodiments, the gantry 84 may also actuate the build platform 28 and 3D part 26p/support structure 26s upward for proper registration with the next layer 22. The same process may then be repeated for each remaining layer 22 of 3D part 26p and support structure 26s.

After the transfusion operation is completed, the resulting 3D part 26p and support structure 26s may be removed from system 10 and undergo one or more post-printing operations. For example, support structure 26s may be sacrificially removed from 3D part 26p using an aqueous-based solution, such as an aqueous alkali solution. Under this technique, support structure 26s may at least partially dissolve in the solution, separating it from 3D part 26p in a hands-free manner.

In comparison, part materials are chemically resistant to aqueous alkali solutions. This allows the use of an aqueous alkali solution to be employed for removing the sacrificial support structure 26s without degrading the shape or quality of 3D part 26p. Examples of suitable systems and techniques for removing support structure 26s in this manner include those disclosed in Swanson et al., U.S. Pat. No. 8,459,280; Hopkins et al., U.S. Pat. No. 8,246,888; and Dunn et al., U.S. Patent Application Publication No. 2011/0186081; each of which are incorporated by reference to the extent that they do not conflict with the present disclosure.

Furthermore, after support structure 26s is removed, 3D part 26p may undergo one or more additional post-printing processes, such as surface treatment processes. Examples of suitable surface treatment processes include those disclosed in Priedeman et al., U.S. Pat. No. 8,123,999; and in Zinniel, U.S. Pat. No. 8,765,045.

As briefly discussed above, the part material compositionally includes a thermoplastic polyurethane (TPU) polymer, a charge control agent, preferably, but optionally, a heat absorber (e.g., a carbon black or an infrared absorber), and optionally one or more additional materials, such as a flow control agent. As mentioned above, the part material is preferably engineered for use with the particular architecture of EP engine 12p or other electrostatographic engine.

To be capable of being used in an EP based additive manufacturing system, the TPU material have a particle size distribution configured to accept a charge, generate an image of a layer of a part and be fused together, including up to about 100 micrometers. A typical particle size range is from about five micrometers to about fifty micrometers. More typically, the particle size ranges from about five micrometers to about 30 micrometers. The TPU particles in the disclosed particle size range are capable of accepting the necessary charge for use in an EP based additive manufacturing system and have the necessary flow capabilities for use therein. For instance, the TPU particles in the disclosed particle size ranges will flow in the EP hardware and in combination with a charge carrier system consisting of charge developing material such as, but not limited to, strontium ferrite aggregated particles that are thirty micrometers or larger in size. The TPU particles in the disclosed ranges accept the necessary charge for use in the EP based additive manufacturing system, while maintain the necessary flow characteristics for use in the EP based additive manufacturing system.

As mentioned above, the part material is engineered for use in an EP-based additive manufacturing system (e.g., system 10) to print 3D parts (e.g., 3D part 80). As such, the part material may also include one or more materials to assist in developing layers with EP engine 12p, to assist in transferring the developed layers from EP engine 12p to layer transfusion assembly 20, and to assist in transfusing the developed layers with layer transfusion assembly 20.

For example, in the electrophotographic process with system 10, the part material is preferably charged triboelectrically through the mechanism of frictional contact charging with carrier particles at development station 58. This charging of the part material may be referred to by its triboelectric charge-to-mass (Q/M) ratio, which may be a positive or negative charge and has a selected magnitude. The Q/M ratio is inversely proportional to the powder density of the part material, which can be referred to by its mass per unit area (M/A) value. For a given applied development field, as the value of Q/M ratio of the part material is increased from a given value, the M/A value of the part material decreases, and vice versa. Thus, the powder density for each developed layer of the part material is a function of the Q/M ratio of the part material.

It has been found that, in order to provide successful and reliable development of the part material onto development drum 44 and transfer to layer transfusion assembly 20 (e.g., via belt 22), and to print 3D part 80 with a good material density, the part material preferably has a suitable Q/M ratio for the particular architecture of EP engine 12p and belt 22. Examples of preferred Q/M ratios for the part material range from about −1 micro-Coulombs/gram (μC/g) to about −50 μC/g, more preferably from about −10 μC/g to about −40 μC/g, and even more preferably from about −12 μC/g to about −25 μC/g, and even more preferably from about −10 μC/g to about −20μC/g. While discussed as a negative charge, the part material can have the same magnitude of a positive charge.

Furthermore, if a consistent material density of 3D part 80 is desired, a selected Q/M ratio (and corresponding M/A value) is preferably maintained at a stable level during an entire printing operation with system 10, development station 58 of EP engine 12p may need to be replenished with additional amounts of the part material. This can present an issue because, when introducing additional amounts of the part material to development station 58 for replenishment purposes, the part material is initially in an uncharged state until mixing with the carrier particles. As such, the part material also preferably charges to the selected Q/M ratio at a rapid rate to maintain a continuous printing operation with system 10.

Accordingly, controlling and maintaining the Q/M ratio during initiation of the printing operation, and throughout the duration of the printing operation, will control the resultant rate and consistency of the M/A value of the part material. In order to reproducibly and stably achieve the selected Q/M ratio, and hence the selected M/A value, over extended printing operations, the part material preferably includes one or more charge control agents, which may be added to the ABS grafted copolymer during the manufacturing process of the part material. One example of a charge control agent is zinc t-butylsalicylate.

The charge control agents preferably constitute from about 0.1% by weight to about 5% by weight of the part material, more preferably from about 0.5% by weight to about 4% by weight, and even more preferably from about 0.75% by weight to about 2% by weight, based on the entire weight of the part material. In an example of an embodiment, about 1 weight % zinc t-butylsalicylate is added to the part material based upon the total weight of the part material.

In many situations, system 10 prints layers 64p with a substantially consistent material density over the duration of the printing operations. Having a part material with a controlled and consistent Q/M ratio allows this to be achieved. However, in some situations, it may be desirable to adjust the material density between the various layers 64p in the same printing operation. For example, system 10 may be operated to run in a grayscale manner with reduced material density, if desired, for one or more portions of 3D part 80.

In addition to incorporating the charge control agents, for efficient operation EP engine 12p, and to ensure fast and efficient triboelectric charging during replenishment of the part material, the mixture of the part material preferably exhibits good powder flow properties. This is preferred because the part material is fed into a development sump (e.g., a hopper) of development station 58 by auger, gravity, or other similar mechanisms, where the part material undergoes mixing and frictional contact charging with the carrier particles.

For example, the part material may constitute from about 1% by weight to about 30% by weight, based on a combined weight of the part material and the carrier particles, more preferably from about 5% to about 20%, and even more preferably from about 5% to about 15%. The carrier particles accordingly constitute the remainder of the combined weight.

The powder flow properties of the part material can be improved or otherwise modified with the use of one or more flow control agents, such as inorganic oxides. Examples of suitable inorganic oxides include hydrophobic fumed inorganic oxides, such as fumed silica, fumed titania, fumed alumina, mixtures thereof, and the like, where the fumed oxides may be rendered hydrophobic by silane and/or siloxane-treatment processes. Examples of commercially available inorganic oxides for use in the part material include those under the tradename “AEROSIL” from Evonik Industries AG, Essen, Germany.

As discussed above, the one or more charge control agents are suitable for charging the ABS copolymer to a selected Q/M ratio for developing layers of the part material at EP engine 12p, and for transferring the developed layers (e.g., layers 64) to layer transfusion assembly 20 (e.g., via belt 22). However, the multiple printed layers in a 3D environment effectively prevents the electrostatic transfer of part material after a given number of layers are printed. Instead, layer transfusion assembly 20 utilizes heat and pressure to transfuse the developed layers together in the transfusion steps.

The part material includes between about 50% by weight and about 99% by weight. More particularly, the part material includes between about 75% by weight and 98% by weight. Even more particular, the part material includes between 85% by weight and about 95% by weight.

In particular, heaters 72 and/or 74 may heat layers 64 and the top surfaces of 3D part 80 and support structure 82 to a temperature near an intended transfer temperature of the part material, such as at least a fusion temperature of the part material, prior to reaching nip roller 70. Similarly, post-fuse heater 76 is located downstream from nip roller 70 and upstream from air jets 78, and is configured to heat the transfused layers to an elevated temperature in the post-fuse or heat-setting step.

Accordingly, the part material may also include one or more heat absorbers configured to increase the rate at which the part material is heated when exposed to heater 72, heater 74, and/or post-heater 76. For example, in embodiments in which heaters 72, 74, and 76 are infrared heaters, the heat absorber(s) used in the part material may be one or more infrared (including near-infrared) wavelength absorbing materials. Absorption of infrared light causes radiationless decay of energy to occur within the particles, which generates heat in the part material.

The heat absorber is preferably soluble or dispersible in the copolymers used for the preparation of the part material with a limited coalescence process, as discussed below.

Additionally, the heat absorber also preferably does not interfere with the formation of the TPU particles, or stabilization of these particles during the manufacturing process. Furthermore, the heat absorber preferably does not interfere with the control of the particle size and particle size distribution of the TPU copolymer particles, or the yield of the TPU copolymer particles during the manufacturing process.

Suitable infrared absorbing materials for use in the part material may vary depending on the selected color of the part material. Examples of suitable infrared absorbing materials include carbon black (which may also function as a black pigment for the part material), as well as various classes of infrared absorbing pigments and dyes, such as those that exhibit absorption in the wavelengths ranging from about 650 nanometers (nm) to about 900 nm, those that exhibit absorption in the wavelengths ranging from about 700 nm to about 1,050 nm, and those that exhibit absorption in the wavelengths ranging from about 800 nm to about 1,200 nm. Examples of these pigments and dyes classes include anthraquinone dyes, polycyanine dyes, metal dithiolene dyes and pigments, tris aminium dyes, tetrakis aminium dyes, mixtures thereof, and the like.

The infrared absorbing materials also preferably do not significantly reinforce or otherwise alter the melt rheologies of the TPU particles. Accordingly, in embodiments that incorporate heat absorbers, the heat absorbers (e.g., infrared absorbers) preferably constitute from about 0.05% by weight to about 10% by weight of the part material, more preferably from about 0.5% by weight to about 5% by weight, and in some more preferred embodiments, from about 1% by weight to about 3% by weight, based on the entire weight of the part material. In an exemplary embodiment, the part material includes about 2.5% by weight, based on the entire weight of the part material.

For use in electrophotography-based additive manufacturing systems (e.g., system 10), the TPU material preferably has a controlled average particle size and a narrow particle size distribution. For example, preferred D50 particles sizes include those up to about 50 micrometers if desired, more preferably from about 5 micrometers to about 40 micrometers, more preferably from about 10 micrometers to about 40 micrometers, and even more preferably from about 10 micrometers to about 30 micrometers.

Additionally, the particle size distributions, as specified by the parameters D90/D50 particle size distributions and D50/D10 particle size distributions, each preferably range from about 1.00 to 1.40, more preferably from about 1.05 and to about 1.35, and even more preferably from about 1.10 to about 1.25. Moreover, the particle size distribution is preferably set such that the geometric standard deviation σ_{g} preferably meets the criteria pursuant to the following Equation 1:

$$σ g \text{∼} \frac{D 90}{D 50} \text{∼} \frac{D 50}{D 10}$$

In other words, the D90/D50 particle size distributions and D50/D10 particle size distributions are preferably the same value or close to the same value, such as within about 10% of each other, and more preferably within about 5% of each other.

The formulated TPU material may then be filled into a cartridge or other suitable container for use with EP engine 12p in system 10. For example, the formulated part material may be supplied in a cartridge, which may be interchangeably connected to a hopper of development station 58. In this embodiment, the formulated part material may be filled into development station 58 for mixing with the carrier particles, which may be retained in development station 58. Development station 58 may also include standard toner development cartridge components, such as a housing, delivery mechanism, communication circuit, and the like.

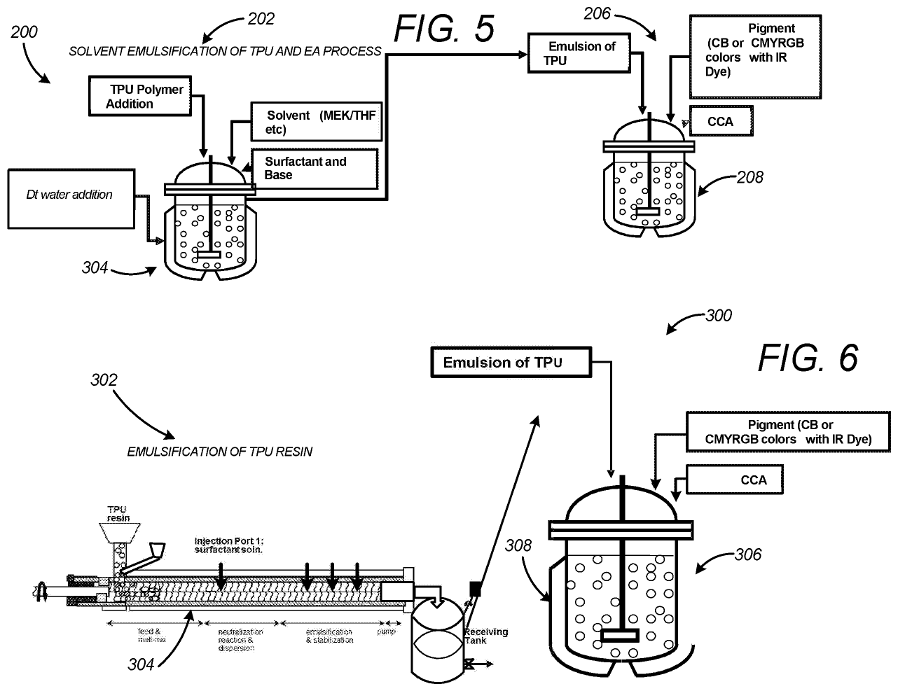

Referring to FIG. 5, a process for manufacturing thermoplastic polyurethane is illustrated at 200. The process includes a solvent and emulsification step 202 conducted in a first reactor 204 followed by a solvent removal. Then an emulsion aggregation step 206 conducted in a second reactor 208 is performed to create the TPU particles. In the solvent and emulsification step 202, thermoplastic polyurethane (TPU) is added to the reactor and a solvent, such as but not limited to, methylethylketone (MEK) or tetrahydrofuran (THF). The TPU and the solvent are organic compounds such that the TPU and the solvent are in a single phase.

Next, a base, such as but not limited to sodium hydroxide, and a surfactant are added to the single phase of the solvent and the TPU. Water, such as deionized water, is added to the TPU and solvent mixture. As water and the TPU/solvent are incompatable and will readily separate, the mixture is homogenized such that the TPU/solvent is dispersed in the water phase where the TPU/solvent droplets within the water phase are less than 500 nanometers or 0.5 microns.

The mixture is then processed through a heat exchanger at 210 where the mixture is raised to a temperature where the solvent undergoes a phase change and is vaporized from a liquid state to a vapor. The vaporized solvent is condensed and recycled for further use.

The emulsion of the TPU in the aqueous liquid without the solvent is sent to the reactor 208. In the reactor 208 the particles of the TPU are combined with a pigment, such as CB or CMYRGM colors with an IR dye, (the particles can contain up to about 5 wt. % of dye based upon the total weight of the dried product) and a percentage of CCA are aggregated together to form particles that are in a controlled range, such as in the range of about 20 microns and about 30 microns. Once aggregated into the selected particle size range, a base is added to freeze the particle size of the aggregate and the mixture is heated to a temperature above the glass transition temperature (Tg) of the TPU polymer.

Referring to FIG. 6, a process for manufacturing thermoplastic polyurethane is illustrated at 300. The process 300 utilizes extrusion-based emulsification at step 302 utilizing an extruder 304 to create a latex emulsion, followed by an emsulsion aggregation step 306 in a stirred reactor 308. The TPU emulsification process utilizes an extruder where solid TPU and a base such as NaOH are added to a first zone where the TPU and NaOH are melt-mixed. A surfactant solution is added to the melt-mixed TPU and NaOH where the reaction is neutralized and a dispersion is created. Next deionized water is added to the dispersion to form an emulsion having an aqueous phase containing particles of TPU.

The emulsion is received in a tank from the extruder 304 and is transported to the reactor 306 where the particles of TPU are aggregated along with pigment/dye and/or charge control agent to form particles that are in a controlled range, such as, by way of example, of about 20 microns and about 30 microns. Once aggregated to the selected particle size range, the mixture is frozen by a base such as sodium or ammonium hydroxide and the mixture is heated to above the Tg of the TPU polymer.

Although the present disclosure has been described with reference to preferred embodiments, workers skilled in the art will recognize that changes may be made in form and detail without departing from the spirit and scope of the disclosure.

1. A part material for printing three-dimensional parts with a selective deposition-based additive manufacturing system, the part material comprising:
a composition comprising:
a thermoplastic polyurethane polymer; and
a charge control agent;
wherein the part material is provided in a powder form having a D90/D50 particle size distribution and a D50/D10 particle size distribution each ranging from about 1.00 to about 1.40; and
wherein the part material is configured for use in the selective deposition-based additive manufacturing system having a layer transfusion assembly for printing the three-dimensional parts in a layer-by-layer manner.

2. The part material of claim 1, wherein the D50 particle size ranges from about 5 micrometers to about 30 micrometers.

3. The part material of claim 1, wherein the D50 particle size ranges from about 10 micrometers to about 30 micrometers.

4. The part material of claim 1, wherein the powder form also has a D90/D50 particle size distribution and a D50/D10 particle size distribution each ranging from about 1.10 to about 1.25.

5. The part material of claim 1, wherein the charge control agent is selected from the group consisting of chromium di-t-butylsalicylic acids and oxy carboxylic acid complexes, zinc di-t-butylsalicylic acids and oxy carboxylic acid complexes, aluminum di-t-butylsalicylic acids and oxy carboxylic acid complexes, and mixtures thereof.

6. The part material of claim 1, wherein the charge control agent constitutes from about 0.1% by weight to about 5% by weight of the part material.

7. The part material of claim 1, and further comprising a heat absorber wherein the heat absorber constitutes from about 0.05% by weight to about 10% by weight of the part material.

8. The part material of claim 1, wherein the selective deposition-based additive manufacturing system comprises an electrostatography-based additive manufacturing system

9. The part material of claim 8, wherein the electrostatography-based additive manufacturing system comprises an electrophotography-based additive manufacturing system.

10. A part material for printing three-dimensional parts with a selective deposition-based additive manufacturing system, the part material comprising:
a composition comprising:
a thermoplastic polyurethane;
a charge control agent constituting from about 0.1% by weight to about 5% by weight of the part material;
a flow control agent constituting from about 0.1% by weight to about 10% by weight of the part material; and
a heat absorber constituting from about 0.05% by weight to about 10% by weight of the part material;
wherein the part material is provided in a powder form having a D90/D50 particle size distribution and a D50/D10 particle size distribution each ranging from about 1.00 to about 1.40; and
wherein the part material is configured for use in the electrophotography-based additive manufacturing system having a layer transfusion assembly for printing the three-dimensional parts in a layer-by-layer manner.

11. The part material of claim 10, wherein the part material is formulated, at least in part, with a solvent inverse emulsification process followed by an emulsion aggregation process.

12. The part material of claim 10, wherein the part material is formulated, at least in part, with an extrusion based solvent inverse emulsification process followed by an emulsion aggregation process.

13. A method for printing a three-dimensional part with a selective deposition-based additive manufacturing system having a layer development engine, a transfer medium, and a layer transfusion assembly, the method comprising:
providing a part material to the electrophotography-based additive manufacturing system, the part material compositionally comprising a charge control agent, and a thermoplastic polyurethane polymer and has a powder form having a D90/D50 particle size distribution and a D50/D10 particle size distribution each ranging from about 1.00 to about 1.40;
triboelectrically charging the part material to a Q/M ratio having a negative charge or a positive charge, and a magnitude ranging from about 5 micro-Coulombs/gram to about 50 micro-Coulombs/gram;
developing layers of the three-dimensional part from the charged part material with the electrophotography engine;
electrostatically attracting the developed layers from the electrophotography engine to the transfer medium;
moving the attracted layers to the layer transfusion assembly with the transfer medium; and
transfusing the moved layers to previously-printed layers of the three-dimensional part with the layer transfusion assembly using heat and pressure over time.

14. The method of claim 13, wherein the powder form of the part material has a D50 particle size ranging from about 5 micrometers to about 30 micrometers.

15. The method of claim 13, wherein the charge control agent constitutes from about 0.1% by weight to about 5% by weight of the part material, and wherein the heat absorber constitutes from about 0.5% by weight to about 10% by weight of the part material.

16. A method of producing thermoplastic polyurethane particles configured for use in a selective deposition-based additive manufacturing system, the method comprising:
dissolving thermoplastic polyurethane in an organic solvent into an organic intermediary composition;
adding an aqueous solution to the organic intermediary composition;
emulsifying the organic intermediary composition in the aqueous solution;
heating the emulsion to evaporate the organic solvent from the emulsion;
agglomerating the thermoplastic polyurethane into particles having a D90/D50 particle size distribution and a D50/D10 particle size distribution each ranging from about 1.00 to about 1.40; and
separating the thermoplastic polyurethane particles from the aqueous solution.

17. The method of claim 16, and further comprising adding an emulsifying agent to the thermoplastic polyurethane prior to the addition of the aqueous solution.

18. The method of claim 16, and further comprising adding a dye to emulsion prior to the agglomeration step.

19. A method of producing thermoplastic polyurethane particles configured for use in a selective deposition-based additive manufacturing system, the method comprising:
mixing thermoplastic polyurethane with an emulsifying agent and a surfactant in an extruder;
adding an aqueous solution to the extruder to form an emulsion;
agglomerating the thermoplastic polyurethane into particles having a D90/D50 particle size distribution and a D50/D10 particle size distribution each ranging from about 1.00 to about 1.40; and
separating the thermoplastic polyurethane particles from the aqueous solution.

20. The method of claim 19, and further comprising adding a dye to emulsion prior to the agglomeration step.
